(19) United States
(12) Patent Application Publication
(10) Pub. No.: US 2022/0398623 A1
(43) Pub. Date: Dec. 15, 2022

(54) INFORMATION PROCESSING APPARATUS AND INFORMATION PROCESSING SYSTEM

(71) Applicant: TOYOTA JIDOSHA KABUSHIKI KAISHA, Toyota-shi (JP)

(72) Inventors: Naoya OKA, Nagakute-shi (JP); Satoshi KITAMURA, Nagoya-shi (JP); Yusuke SOBUE, Nagoya-shi (JP); Seira NAKADA, Nagoya-shi (JP); Mami MORI, Nagoya-shi (JP); Masato MORISHIMA, Nagoya-shi (JP); Yasuyuki NUNOKAWA, Nagoya-shi (JP)

(73) Assignee: TOYOTA JIDOSHA KABUSHIKI KAISHA, Toyota-shi (JP)

(21) Appl. No.: 17/828,182

(22) Filed: May 31, 2022

(30) Foreign Application Priority Data
Jun. 10, 2021 (JP) 2021-097514

(51) Int. Cl. G06Q 30/02

(52) U.S. Cl. CPC G06Q 30/0239

(57) ABSTRACT

An information processing apparatus that provides an online service associated with movement is configured to: acquire skill information that is information about driving skills for a predetermined user; and give an incentive associated with the online service to the user based on the skill information.

### CROSS-REFERENCE TO RELATED APPLICATION

This application claims priority to Japanese Patent Application No. 2021-097514 filed on Jun. 10, 2021, incorporated herein by reference in its entirety.

### BACKGROUND

### 1. Technical Field

The present disclosure relates to an information processing apparatus and an information processing system.

### 2. Description of Related Art

A technique of measuring the driving skills of a user is known. For example, Japanese Unexamined Patent Application Publication No. 2019-028654 (JP 2019-028654 A) discloses an information processing apparatus that diagnoses driving by a user based on information collected from a portable terminal owned by the user.

### SUMMARY

The present disclosure provides an information processing apparatus and an information processing system that issue an incentive based on the driving skills of a user.

A first aspect of the present disclosure provides an information processing apparatus that provides an online service associated with movement, the information processing apparatus including a control unit configured to: acquire skill information that is information about driving skills for a predetermined user; and give an incentive associated with the online service to the user based on the skill information.

A second aspect of the present disclosure provides an information processing system including: a first device that provides an online service associated with movement; and a second device that provides skill information that is information about driving skills of a user, in which the first device is configured to give an incentive associated with the online service to the user based on the skill information provided from the second device.

Another aspect of the present disclosure provides a program that causes a computer to execute a method executed by the apparatus described above, or a computer-readable storage medium that stores the program in a non-transitory manner.

With the present disclosure, an incentive can be issued based on the driving skills of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an overview of a reservation system;

FIG. 2 illustrates the configuration of a server device, a user terminal, and an external device;

FIG. 3 illustrates an example of spot data stored in a storage unit;

FIG. 4 illustrates an example of reservation data generated by the server device;

FIG. 5A illustrates an example of incentive data stored in the storage unit;

FIG. 5B illustrates another example of the incentive data stored in the storage unit;

FIG. 6 is a flowchart of a process performed by a control unit in a first embodiment;

FIG. 7 illustrates an example of a screen for searching for a spot;

FIG. 8 illustrates an example of a screen that presents a list of services;

FIG. 9 illustrates the configuration of a server device according to a second embodiment;

FIG. 10 illustrates an example of evaluation data according to the second embodiment;

FIG. 11 is a flowchart of a process performed by a control unit in the second embodiment;

FIG. 12 is a flowchart of a process performed by the control unit in the second embodiment;

FIG. 13 illustrates grouping of users according to a fourth embodiment; and

FIG. 14 illustrates grouping of users according to a modification of the fourth embodiment.

### DETAILED DESCRIPTION OF EMBODIMENTS

An information processing apparatus according to an aspect of the present disclosure is an information processing apparatus that provides an online service associated with movement, the information processing apparatus including a control unit configured to: acquire skill information that is information about driving skills of a predetermined user; and give an incentive associated with the online service to the user based on the skill information.

The information processing apparatus can be a device that provides an online service related to movement, for example. Examples of such a service include a service that sells a travel product, a service that collectively make reservations for a plurality of spots (e.g. accommodation facilities, restaurants, and parking lots) to be visited during movement, etc. The skill information is information about the driving skills of the user. Examples of the skill information include data that indicate driving skills evaluated by a third party, a history of taking driving lessons, etc. The control unit gives an incentive (e.g. a discount on a product or a service) associated with the online service based on the skill information. Consequently, a travel product etc. can be sold to users that have driving skills with preferential treatment, for example. The incentive may be a discount, points, etc. that can be used on the online service, or may be a discounted or free service that can be used at a spot (such as a shop) that can be reserved on the online service.

In the information processing apparatus described above, the skill information may be information indicating that the user previously received a first service related to acquisition of the driving skills using the online service. In the information processing apparatus described above, the control unit may acquire the skill information from a device associated with the first service. The first service can be driving lessons, lessons for unskilled drivers, etc., for example.

In the information processing apparatus described above, the control unit may acquire the skill information from a terminal carried when the user drives a vehicle. In the information processing apparatus described above, the skill information may be generated by application software (e.g. application software that diagnoses driving) that operates on a portable terminal, etc.

In the information processing apparatus described above, the control unit may sell a service to be provided at a predetermined spot through the online service. In the information processing apparatus described above, the service to be provided at a predetermined spot may be sold alone, or a travel product including a plurality of services may be sold, through the online service.

In the information processing apparatus described above, the control unit may generate a group including users that have purchased the service, and select users who are targets to be given the incentive from among the group.

The group preferably includes a plurality of users that has similar attributes. Examples of the attribute include age, gender, destination area, movement path, etc.

In the information processing apparatus described above, the control unit may generate the group for each area of a destination and for each time slot of arrival at the area. The control unit may generate the group for each area of a destination or for each time slot of arrival at the area. In the information processing apparatus described above, the control unit may divide the group further based on a degree of similarity of a path to the destination. That is, in the information processing apparatus described above, a plurality of the users that makes similar movements may be formed into a group, and the user to be given an incentive may be selected from the group.

In the information processing apparatus described above, the control unit may determine a driving skill level of the user based on the skill information. In the information processing apparatus described above, the control unit may give the incentive to the user acknowledged to have the driving skill level of a predetermined value or more. Consequently, it is possible to cause a plurality of users to compete with each other in driving skills, which leads to improving their motivation. In the information processing apparatus described above, an upper limit number of the users to be given the incentive may be defined for each group.

The information processing system according to another aspect of the present disclosure includes: a first device configured to provide an online service associated with movement; and a second device configured to provide skill information that is information about driving skills of a user. The first device is configured to give an incentive associated with the online service to the user based on the skill information provided from the second device.

In the information processing system described above, the second device may be a device associated with a first service related to acquisition of the driving skills. The second device may be configured to provide the skill information when the user receives the first service using the online service.

In the information processing system described above, the first device may be configured to sell a service to be provided at a predetermined spot through the online service.

In the information processing system described above, the first device may be configured to generate a group including the users that have purchased the service, and to select the user who is a target to be given the incentive from among the group.

In the information processing system described above, the first device may be configured to generate the group for each area of a destination.

In the information processing system described above, an upper limit number of the users to be given the incentive may be defined for each of the groups.

In the information processing system described above, the first device may be configured to determine a driving skill level of the user based on the skill information.

In the information processing system described above, the first device may be configured to give the incentive to the user acknowledged to have the driving skill level of a predetermined value or more.

Specific embodiments of the present disclosure will be described below with reference to the drawings. The hardware configuration, the module configuration, the functional configuration, etc. described in relation to the embodiments are not intended to limit the technical scope of the disclosure to only such embodiments unless specifically stated otherwise.

### First Embodiment

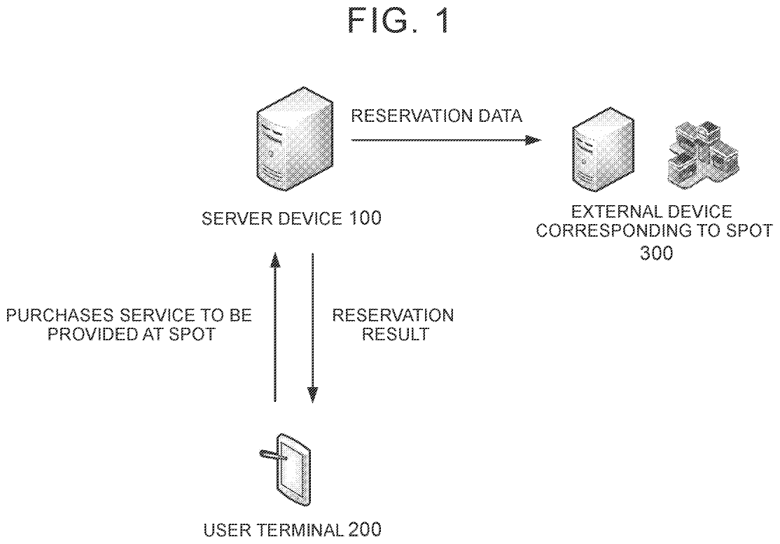

An overview of a reservation system according to a first embodiment will be described with reference to FIG. 1. The reservation system according to the present embodiment is configured to include a server device 100 that sells services to be provided at a plurality of spots (e.g. restaurants and play spots), a plurality of user terminals 200, and a plurality of external devices 300.

The server device 100 sells a service (e.g. an accommodation service and a catering service) to be provided at a predetermined spot based on a request transmitted from the user terminal 200. Specifically, the server device 100 manages the spots and the content of the services to be provided at such spots, determines a service to be used by a user based on a request from the user, and makes a reservation (generates reservation data). The server device 100 also has a function of standing in to pay the fee for using such spots. Consequently, the user can collectively make reservations for a plurality of spots, and can receive various services by just visiting the spots related to the reservations.

While the server device 100 sells a service to be provided at a spot in the present embodiment, the server device 100 can also sell a travel product that includes a plurality of services and modes of transportation.

The user terminal 200 is a computer owned by a user that uses a reservation service. The user can access the server device 100 via the user terminal 200, and request to make a reservation for a spot or a service. The system may include a plurality of user terminals 200.

The external device 300 is a server device associated with each of the spots. The external device 300 receives reservation data from the server device 100. The system may include a plurality of external devices 300. The external device 300 may be a device installed at each of a plurality of spots (e.g. shops), or may be a device that manages a plurality of spots (e.g. manages a plurality of shops that belongs to the same group), for example.

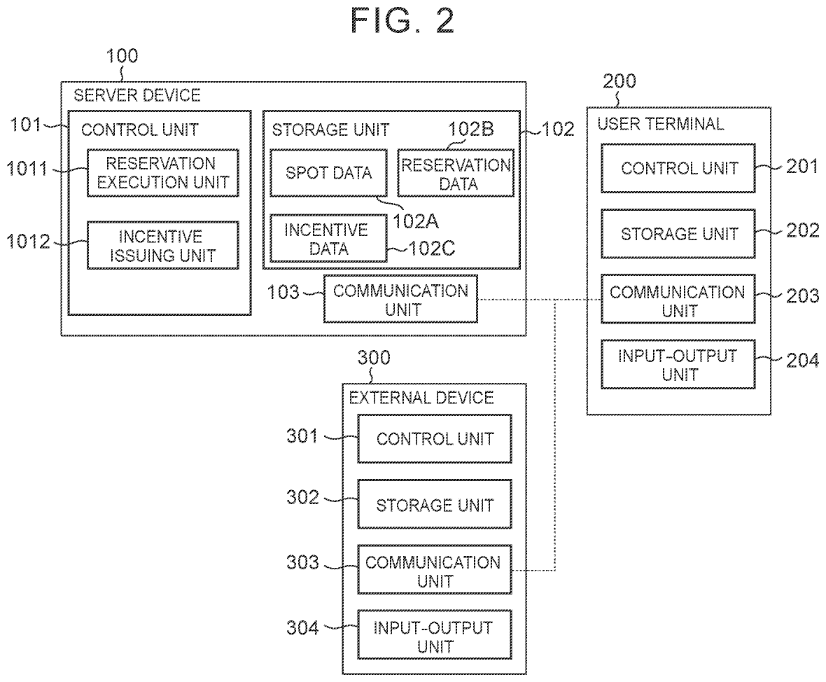

FIG. 2 illustrates the constituent elements of the server device 100, the user terminal 200, and the external device 300 included in the information processing system according to the present embodiment in more detail. The user terminal 200 will first be described. The user terminal 200 is a computer that is used by an individual, such as a personal computer, a smartphone, a mobile phone, a tablet computer, and a personal information terminal, for example. The user terminal 200 is configured to include a control unit 201, a storage unit 202, a communication unit 203, and an input-output unit 204.

The control unit 201 is a computation device that governs control performed by the user terminal 200. The control unit 201 can be implemented by a computation processing device such as a central processing unit (CPU). The control unit 201 executes a function of performing interaction by accessing the server device 100. This function may be implemented by a web browser that operates on the user terminal 200 or dedicated application software.

The storage unit 202 is configured to include a main storage device and an auxiliary storage device. The main storage device is a memory in which a program to be executed by the control unit 201 and data to be used by the control program are to be developed. The auxiliary storage device is a device in which the program to be executed by the control unit 201 and data to be used by the control program are stored. The auxiliary storage device may store the program to be executed by the control unit 201 as packaged as an application. The auxiliary storage device may also store an operating system for executing such an application. The process to be described below is performed as the program stored in the auxiliary storage device is loaded into the main storage device and executed by the control unit 201.

The main storage device may include a random access memory (RAM) and a read only memory (ROM). The auxiliary storage device may include an erasable programmable ROM (EPROM) or a hard disk drive (HDD). The auxiliary storage device may further include a removable medium, that is, a portable storage medium.

The communication unit 203 is a wireless communication interface that connects the user terminal 200 to a network. The communication unit 203 is configured to be able to communicate with the server device 100 via a mobile communication service such as a wireless LAN, 3G, LTE, 5G, for example. The input-output unit 204 is a unit that receives an input operation performed by the user, and that presents information to the user. In the present embodiment, the input-output unit 204 is composed of a single touch panel display. That is, the input-output unit 204 is constituted from a liquid crystal display, a control unit therefor, a touch panel, and a control unit therefor.

The external device 300 is a server device associated with each of the spots. The external device 300 is a general-purpose computer such as a personal computer and a tablet computer, for example. The external device 300 is configured to include a control unit 301, a storage unit 302, a communication unit 303, and an input-output unit 304. The constituent elements of the external device 300 are similar to those of the user terminal 200, and therefore will not be described in detail.

Next, the server device 100 will be described. The server device 100 is a device that presents to the user the spots and the content of the services to be provided at the spots, and that sells a service based on a request transmitted from the user terminal 200.

In the present embodiment, the server device 100 may be configured to be able to execute a web server that interacts with the user terminal 200. In this case, the user can purchase a service as the user terminal 200 accesses the web server using a browser, for example. The server device 100 may provide a service by means other than the web server. For example, the server device 100 may execute a service to interact with dedicated application software installed in the user terminal 200 using a predetermined protocol.

The server device 100 can be constituted of a general-purpose computer. That is, the server device 100 can be constituted as a computer that includes a processor such as a CPU and a graphics processing unit (GPU), a main storage device such as a RAM and a ROM, and an auxiliary storage device such as an EPROM, a hard disk drive, and a removable medium. The auxiliary storage device stores an operating system (OS), various programs, various tables, etc., and can implement various functions that match a predetermined object, to be discussed later, by loading the programs stored in the auxiliary storage device into a work area of the main storage device and executing the programs such that the various constituent units are controlled through execution of the programs. Some or all of the functions may be implemented by a hardware circuit such as an application specific integrated circuit (ASIC) and a field programmable gate array (FPGA).

The control unit 101 is a computation device that governs control performed by the server device 100. The control unit 101 can be implemented by a computation processing device such as a CPU. The control unit 101 is configured to include two functional modules, namely a reservation execution unit 1011 and an incentive issuing unit 1012. The functional modules may be implemented by a CPU executing a stored program.

The reservation execution unit 1011 determines a spot and a service to be reserved by a user based on the result of interaction performed with the user terminal 200 owned by the user, and generates reservation data.

In the present embodiment, the spots are facilities to be used by users at the destination of movement. Examples of the spots include accommodation facilities, restaurants, amusement facilities, etc. The spots may also be facilities that provide services related to automobiles, such as parking lots, car wash stations, and gas stations. The spots may further be facilities (experience-based facilities) that provide activities and experiences. The spots may further be facilities (driving schools) that give driving lessons for automobiles.

The services provided by the spots are defined for each spot. For example, when the spot is an accommodation facility, the services may be defined for each type of guest rooms. When the spot is a restaurant, the services may be defined for each course of dishes to be served. When the spot is a facility that gives driving lessons for automobiles, the services may be defined for each vehicle type or plan of lessons.

The reservation execution unit 1011 determines a combination of a spot to be used by a user and a service to be received by the user at the spot. After determining such a combination, the reservation execution unit 1011 generates data (reservation data) for making a reservation for the spot, and transmits the reservation data to the external device 300 corresponding to the target spot. Consequently, the user can collectively make reservations for the facilities etc. that the user desires to use. The reservation execution unit 1011 may further handle advance payment of the fee related to the reservations.

The incentive issuing unit 1012 gives an incentive to a user that has used the reservation service. In the present embodiment, the incentive issuing unit 1012 gives a predetermined incentive to a user when the user has purchased a service using the reservation service and the user can be evaluated to have a certain level of driving skills or higher.

The incentive is typically a discount coupon, points, etc. that can be used for the reservation service. To give an incentive, the incentive issuing unit 1012 gives an electronic coupon or points to an account associated with the user. The electronic coupon or points may be used on the same day. For example, when the server device 100 handles advance payment of the fee for a service related to a reservation, the fee can be discounted or rendered free at the timing of payment. Consequently, the user can receive preferential financial treatment when the user purchases a service to be provided at a spot or a travel product.

The storage unit 102 is configured to include a main storage device and an auxiliary storage device. The main storage device is a memory in which a program to be executed by the control unit 101 and data to be used by the control program are to be developed. The auxiliary storage device is a device in which the program to be executed by the control unit 101 and data to be used by the control program are stored.

The storage unit 102 also stores spot data 102A, reservation data 102B, and incentive data 102C.

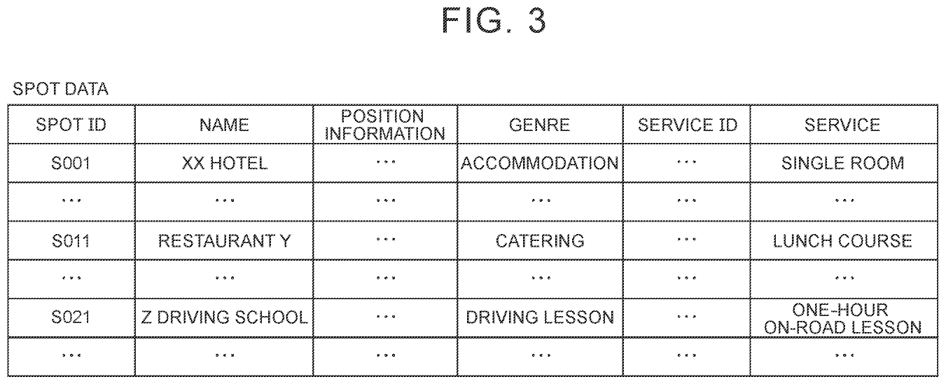

The spot data 102A are data that define a plurality of spots to be reserved and services to be provided at the spots. FIG. 3 illustrates an example of the spot data 102A. The spot data 102A include the identifier of the spot, the name of the spot, the position information on the spot, information about the genre of the spot, the identifier of a service to be provided, and detailed information on the service, for example.

When there is a limit to the resource (e.g. the number of guest rooms and the number of guest seats) for a service that can be provided at each spot, it is occasionally necessary to check availability before receiving a reservation. In order to handle such occasions, the spot data 102A may include data for determining whether a reservation can be made. Such data can include reference to a booking register, for example. The reservation execution unit 1011 can present whether a reservation can be made to the user by accessing the booking register via the data. The booking register may be kept by the server device 100, or may be kept by the external device 300 corresponding to each spot.

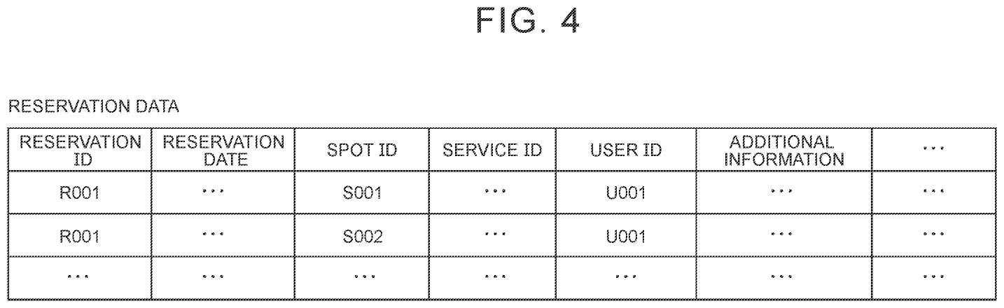

The reservation data 102B are reservation data generated by the reservation execution unit 1011. The generated reservation data are transmitted to the external device 300, and stored in the storage unit 102. FIG. 4 is an example of the reservation data 102B. The reservation data 102B include information that identifies a combination of the reservation, the spot, the service, and the user and additional information. The additional information is additional information that is necessary to apply for a reservation at a spot. Examples of the additional information include the reservation time (arrival time or check-in time), the number, age, and gender of the users, and the contact of the users.

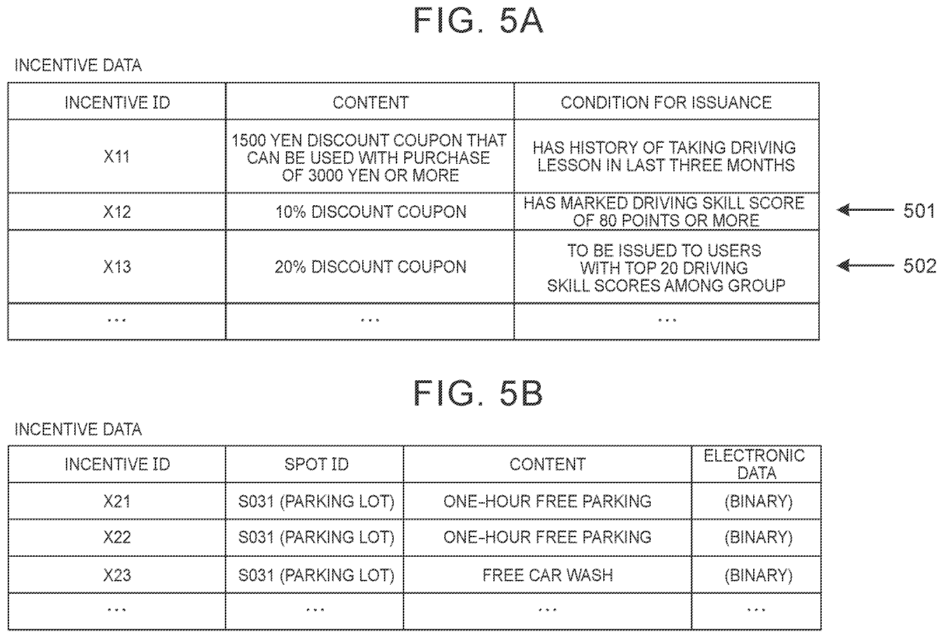

The incentive data 102C are data that define incentives to be provided to the users. FIG. 5A illustrates an example of the incentive data 102C. The incentive data 102C include the identifier of the incentive, the content of the incentive, and data about the condition for issuing the incentive, for example. The amount of preferential treatment to be given as an incentive may be a constant amount, or may be determined based on the amount (e.g. 10% of the total amount of payment) to be paid by the user.

The data described earlier may be constructed by a program of a database management system (DBMS) executed by a processor managing data stored in a storage device. In this case, the data can be a relational database, for example.

The communication unit 103 is a communication interface that connects the server device 100 to a network. The communication unit 103 is configured to include a network interface board or a wireless communication interface for wireless communication, for example.

The configuration illustrated in FIG. 2 is exemplary, and all or some of the illustrated functions may be executed using an exclusively designed circuit. The program may be stored or executed by a combination of a main storage device and an auxiliary storage device other than that illustrated in the drawing.

Next, a process executed by the server device 100 will be described. The server device 100 makes a reservation of a spot based on a request from a user. In this event, an incentive is given to the user when the user has a history of taking a driving lesson at a spot (hereinafter referred to as a “driving learning facility”) intended to improve driving skills in a predetermined period in the past. The driving learning facility may be a private driving school, or may be one operated by a public organization.

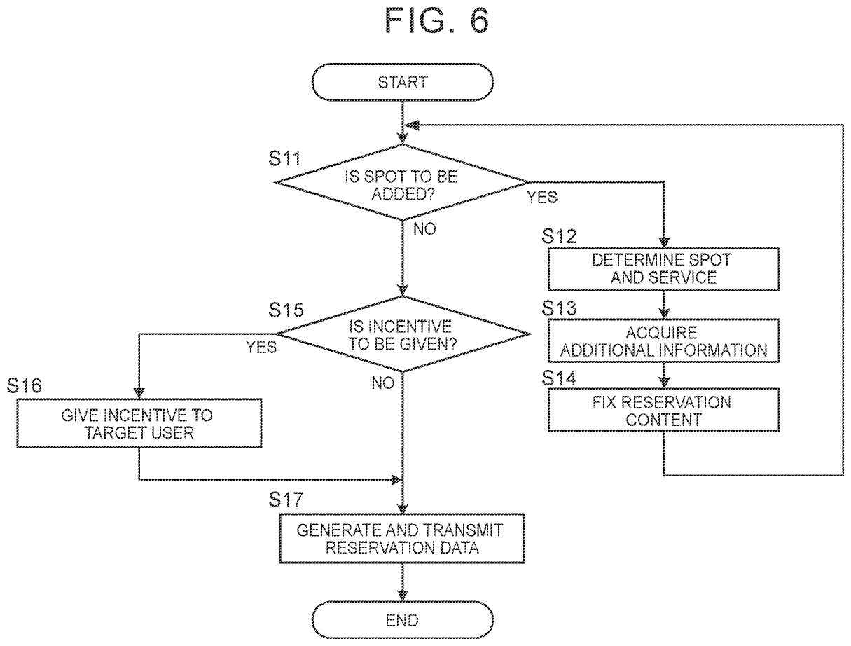

FIG. 6 is a flowchart illustrating the process executed by the server device 100. The flowchart illustrated in FIG. 6 is executed at the timing when the user logs in to the reservation service provided by the server device 100, for example. It is assumed that the server device 100 has completed the identification of the user at the timing to start the process.

In step S11, the server device 100 determines whether a new spot is to be added as a target for reservation. In this step, a request related to a reservation for an accommodation facility, a restaurant, an amusement facility, a driving learning facility, a parking lot, etc. is acquired from the user, for example. When an affirmative determination is made in this step, the process transitions to step S12. When a negative determination is made in this step, the process transitions to step S15.

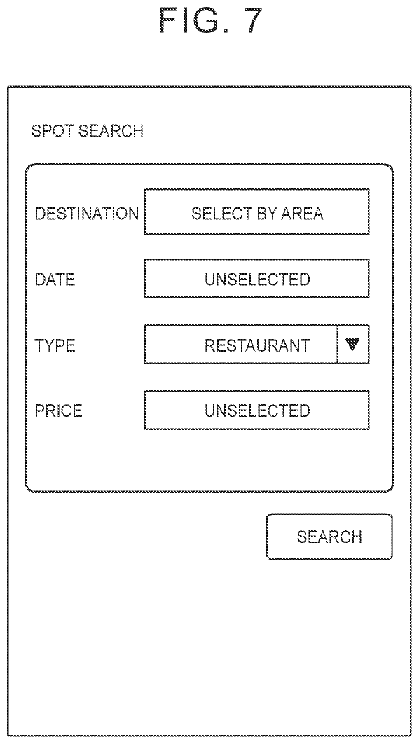

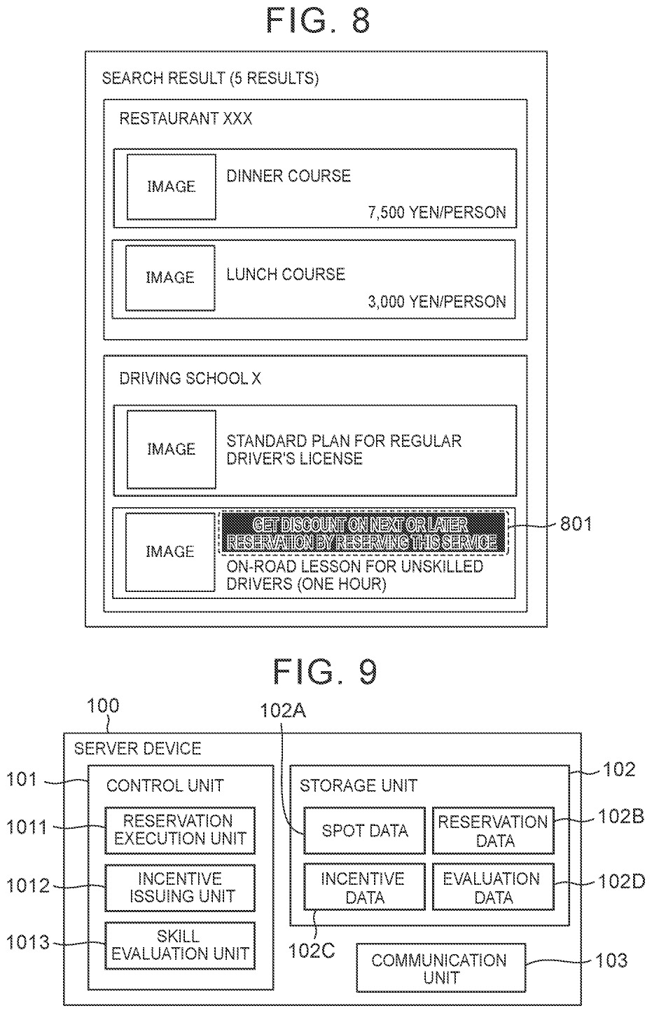

In step S12, a spot and a service to be used are determined. A search for a spot and a service can be made using the existing technique. For example, the reservation execution unit 1011 may provide a search screen such as that in FIG. 7 to the user, and allow the user to search for a spot. In addition, the reservation execution unit 1011 may provide a list of spots and services such as that illustrated in FIG. 8 in accordance with a search condition, and allow the user to make a choice. The services that can be reserved can be determined by referencing the spot data 102A and the booking register, for example. In this event, when there is a service (e.g. a driving lesson at a driving learning facility) that triggers an incentive to be given, the presence of such a service may be indicated to the user as indicated by numeral 801.

Next, in step S13, additional information about the use is acquired. When the spot is an accommodation facility, date and time information (check-in date and check-in time), the number, age, and gender of the guests, etc. are acquired as the additional information, for example.

When the spot is a facility not related to accommodation, such as a restaurant, an amusement facility, an experience-based facility, or a parking lot, unlike the present example in which the spot is an accommodation facility, additional information that is suitable for the spot may be acquired. When the spot is a parking lot, for example, information about the vehicle may be the additional information. When the spot is an experience-based facility, meanwhile, information about the age etc. of the participant may be the additional information. In step S14, the content of the reservation is fixed based on an input from the user.

When the addition of a spot is completed, the process returns to step S11, and the server device 100 determines whether it is necessary to add another spot. When another spot is to be added, the processes in steps S11 to S14 are repeatedly performed.

While a plurality of spots is added sequentially in the flowchart in FIG. 6, it is also possible to allow the user to designate a condition, and automatically extract and present a combination of a spot and a service that match the designated condition. Examples of such a condition include the area to be traveled, the departure location, the date and time of departure, the spot desired to be visited, the genre of the spot desired to be visited, the date and time of return, etc. Consequently, an itinerary can be generated automatically. The generated itinerary may be editable by the user. For example, the user may be allowed to add, delete, or replace a spot, replace a service, etc.

In step S15, the server device 100 determines whether to give an incentive to the user that has made the reservation. In this step, the previous reservation data corresponding to the user are referenced, and an affirmative determination is made when the user has a history of making a reservation for a driving lesson at a predetermined driving learning facility in a predetermined period in the past. A negative determination is made otherwise. The target spot (driving learning facility) and the target service (driving lesson) may be stored in advance in the spot data 102A. When an affirmative determination is made in step S15, the process transitions to step S16. When a negative determination is made in step S15, the process transitions to step S17.

In step S16, the incentive issuing unit 1012 gives an incentive to the target user. Specifically, the incentive issuing unit 1012 gives an electronic coupon or points that can be used for the reservation service to an account associated with the user.

In step S17, the reservation execution unit 1011 generates data (reservation data) for making a reservation for the spot to be used by the user. In this step, reservation data such as those indicated in FIG. 4 are generated, and transmitted to the external device 300 corresponding to the target spot. In this step, the fee related to the reservation may be paid in advance. When an incentive is given in step S16, the user can pay the fee using the incentive (e.g. using the points that have been given). Consequently, the user can receive a discount etc. related to the present reservation.

With the reservation system according to the first embodiment, as has been described above, an incentive that can be used for the reservation service is given when a user that has a history of receiving a service related to the acquisition of driving skills makes a reservation for a predetermined spot. Consequently, it is possible to improve the skills of the user.

### Modification of First Embodiment

In the first embodiment, while the server device 100 determines whether to give an incentive to a user (step S15) after the user adds a spot, the server device 100 may determine whether to give an incentive to the user before the processes in steps S11 to S14. This determination may be made at the timing when the user logs in to the reservation service, for example. Alternatively, the choice of a spot etc. may be made after notifying the user that an incentive has been given.

In the first embodiment, while an incentive is given when a second or subsequent reservation is made, an incentive may be given at the timing when the user makes a reservation for a driving learning facility (i.e. when a first reservation is made).

In the first embodiment, while an incentive is provided on the reservation service, an incentive may be provided at a spot. Examples of such an incentive include the provision of a free (or discounted) service at an accommodation facility and a restaurant, for example. For example, the incentive may be upgrading of a guest room, provision of a product or a service for free (or at a discounted price), etc. When the spot to be used is a parking lot, the incentive may be a free (or discounted) parking or car wash service.

In this case, the incentive issuing unit 1012 may transmit an electronic coupon to the user terminal 200 as the incentive. The electronic coupon may be data that can be transferred between terminals, or may be a barcode or a two-dimensional code that is optically readable, for example. Alternatively, the electronic coupon may be image data etc. Consequently, the users that have visited the spot can receive various preferential treatments.

FIG. 5B illustrates an example of the incentive data 102C for a case where the incentive is provided at a spot. The incentive data include the identifier of the incentive, the identifier of the spot, the content of the service to be provided, electronic data for generating the electronic coupon described earlier, etc. The incentive issuing unit 1012 can provide an electronic coupon using the incentive data in step S16. The spot at which an incentive is provided may be determined by the server device 100, or may be selected by the user.

### Second Embodiment

In the first embodiment, an incentive is given to a user that has a history of taking a driving lesson. In the second embodiment, on the contrary, the target to be given an incentive is determined using the result of evaluating the driving skills of users.

FIG. 9 illustrates the constituent elements of a server device 100 according to the second embodiment in detail. The second embodiment is different from the first embodiment in that the server device 100 (control unit 101) further includes a skill evaluation unit 1013, and that the storage unit 102 further stores evaluation data 102D.

The skill evaluation unit 1013 acquires data (corresponding to the “skill information” according to the present disclosure; hereinafter referred to as “evaluation data”) about the driving skills of a user that uses the reservation service. The evaluation data are generated by the external device 300 corresponding to a spot at which a driving lesson is given. For example, an instructor at a driving learning facility evaluates driving of a user, and inputs the evaluation result using the external device 300. The external device 300 generates evaluation data based on the input evaluation, and transmits the evaluation data to the server device 100.

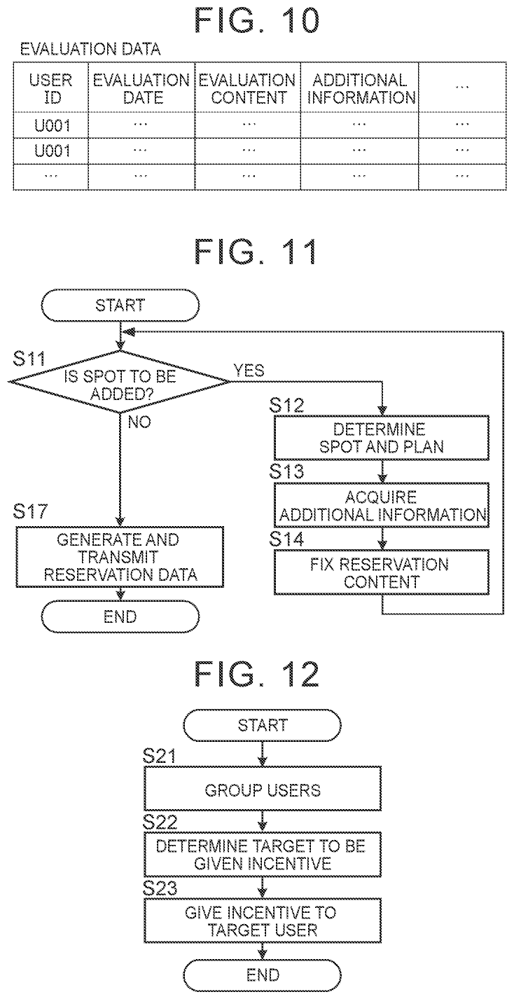

FIG. 10 is an example of the evaluation data 102D. The evaluation data 102D include the identifier of the user, the date on which the driving skills were evaluated, the content of the evaluation of the driving skills, additional information (e.g. the identifier of a person that evaluated the driving skills etc.), etc.

In the second embodiment, in step S15, the incentive issuing unit 1012 determines the driving skill level of the user with reference to the evaluation data 102D. In addition, the incentive issuing unit 1012 determines whether to give an incentive to the user based on the determination result. For example, when the evaluation data include a score obtained by quantifying the driving skills, a user that has a score of a predetermined value or more is determined as the target to be given an incentive. The incentive data 102C may include a threshold of a score as a condition for giving an incentive etc. as indicated by numeral 501 in FIG. 5A.

In this manner, with the second embodiment, an incentive can be given in accordance with the driving skill level of the user.

### Third Embodiment

In the second embodiment, driving by a user is evaluated at a driving learning facility, and the evaluation result is acquired by the server device 100. Meanwhile, it is not necessary that driving should be evaluated by a human. For example, application software for evaluating driving may be provided by a driving learning facility or the operator of the reservation service, and the user may evaluate his or her own driving using the software.

In the present embodiment, the user terminal 200 is configured to be able to execute application software for evaluating driving. The software acquires the position information, speed, acceleration, etc. of a vehicle driven by the user via a sensor, a global positioning satellite (GPS) module, etc. of the user terminal 200, and generates evaluation data based on such data, for example. A known method can be used to generate evaluation data. For example, the smoothness of driving may be determined based on the measured acceleration, or whether the vehicle is traveling at an appropriate speed may be determined based on the position information or the speed. A total score may be calculated based on such determination results.

The software executed by the user terminal 200 can generate evaluation data at the timing when a predetermined amount of data is accumulated, and transmit the evaluation data to the server device 100. Meanwhile, the server device 100 receives the evaluation data from the user terminal 200, stores the evaluation data, and determines, based on the evaluation data, whether an incentive is to be given to the corresponding user in step S15. In this manner, with the third embodiment, driving skills can be evaluated at a low cost.

### Fourth Embodiment

In the first to third embodiments, an incentive is given at the timing when a user that meets a condition has made a new reservation for a spot. In a fourth embodiment, on the contrary, a plurality of users that has made a reservation for a spot is grouped, and an incentive is given to a certain number of users (e.g. in descending order of scores in which driving skills are quantified) for each group.

FIG. 11 is a flowchart of a process executed by the server device 100 in the fourth embodiment. In the present embodiment, the processes in steps S15 and S16, that is, the process of giving an incentive when making a reservation, are omitted. Then, the user to which an incentive is to be given is determined at a predetermined timing after reservation data are accumulated.

FIG. 12 is a flowchart of a process of determining the user to which an incentive is to be given in the fourth embodiment. The illustrated process is executed by the incentive issuing unit 1012 at a predetermined timing (e.g. daily at a predetermined time).

First, in step S21, a plurality of users that has made a reservation for a spot is grouped. Grouping can be performed based on the area in which the destination of the user is located and the date on which the destination is to be visited.

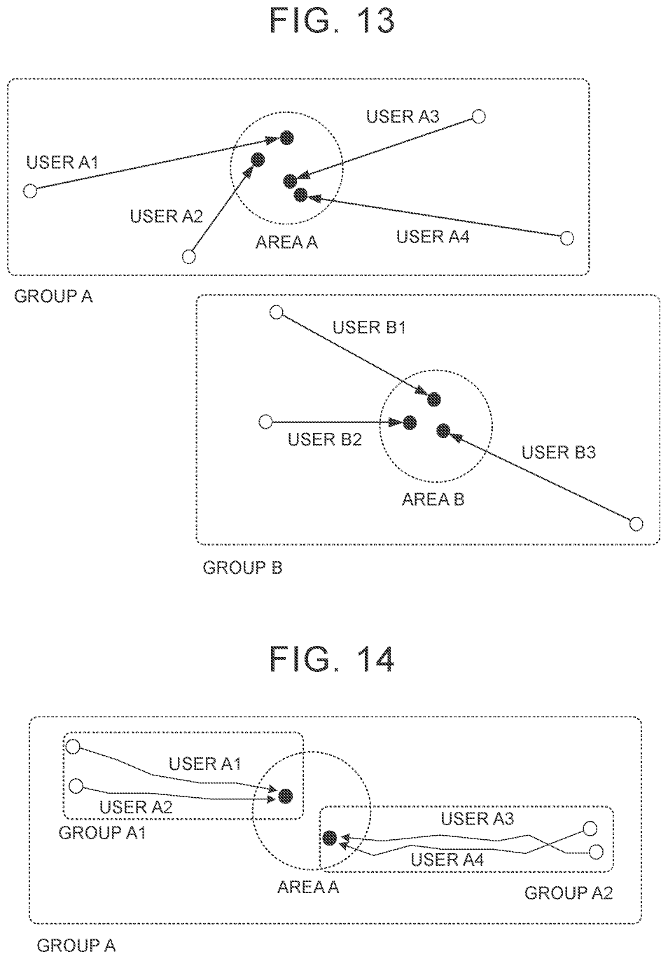

FIG. 13 illustrates users that move to use reserved spots on a certain date. It is assumed that a total of seven users move on the same day in order to use the reserved spots. In the drawing, the white circles represent the departure locations of the users, and the black circles represent the destinations (reserved spots) of the users. How each user moves can be determined by referencing the reservation data 102B.

In the example described here, grouping is performed for each area to which spots as the destinations of the users belong. In the illustrated example, it is assumed that users A1 to A4 move to spots located in an area A as the destinations, and that users B1 to B4 move to spots located in an area B as the destinations. In this case, a group A is generated as a group of users whose destinations are located in the area A, and a group B is generated as a group of users whose destinations are located in the area B.

While grouping is performed for each date, the criterion for generating groups is not limited thereto. For example, groups may be generated based on a criterion such as a “group of users that arrive at the area A on the consecutive Saturday and Sunday”. Alternatively, grouping may be performed for each time slot such as a “group of users that arrive at the area B in the morning of the day”, for example. Alternatively, users that have purchased the same travel product may be included in the same group. Consequently, a plurality of users that moves can be grouped.

Each user that belongs to a group may be informed of information about the group. For example, the user terminal 200 associated with each user may be notified in advance of the criterion for generating the group, the number of users that belong to the group, the number of users to be given an incentive, etc.

Next, in step S22, the user to be given an incentive is determined for each group. The target to be given an incentive can be determined in accordance with a predetermined rule. For example, a rule that “an incentive is given to users whose driving skill score is ranked as being in the top 20% of a plurality of users that belongs to a group” may be used. The rule may be included in the incentive data 102C as indicated by numeral 502 in FIG. 5A.

In step S23, an incentive is given to the target user. The user has already made a reservation for a spot that the user is to use. Therefore, in the present embodiment, an incentive is given to the target user by any of the following.

(1) An electronic coupon that can be used at the reserved spot is given.
(2) An electronic coupon that can be used at a desired spot other than the reserved spot is given.

The target user can receive a predetermined service by presenting the electronic coupon at a predetermined spot. An incentive is preferably given at a timing earlier than the target user arrives at the destination. In the present embodiment, an electronic coupon can be provided using the incentive data described with reference to FIG. 5B in relation to the modification of the first embodiment.

In the fourth embodiment, as described above, a group of users that have purchased a service to be provided at a spot is generated, and the target to be given an incentive is determined for each group. With such a configuration, users that take similar actions can be caused to compete with each other in driving skills.

While groups are generated based on the destination and the arrival time slot of users in the present embodiment, groups may be generated (or divided) based on other criteria. For example, when the movement path of each user from the departure location to the destination is known, the generated groups may be divided based on the degree of similarity of the movement path. FIG. 14 illustrates an example in which a group (group A) including four users whose destinations are in the same area is divided based on the degree of similarity of the movement path. In the present example, a group A1 including users A1 and A2 and a group A2 including users A3 and A4 are further generated. The degree of similarity of the movement path can be calculated by a known technique. The movement path of each user may be calculated by the server device 100 that has received a reservation for a spot.

### Modifications

The embodiments described above are merely exemplary, and the present disclosure may be modified as appropriate without departing from the spirit and scope of the present disclosure. For example, the processes and the means described in the present disclosure can be implemented as freely combined unless any technical contradiction occurs.

A process described as being performed by a single device may be executed by a plurality of devices in a shared manner. Alternatively, a process described as being performed by different devices may be executed by a single device. In a computer system, the hardware configuration (server configuration) that implements various functions is flexibly changeable.

The present disclosure can also be implemented by supplying a computer with a computer program that implements the functions described in relation to the above embodiments and one or more processors of the computer reading and executing the program. Such a computer program may be provided to the computer through a non-transitory computer-readable storage medium that is connectable to a system bus of the computer, or may be provided to the computer via a network. Examples of the non-transitory computer-readable storage medium include any type of disk such as a magnetic disk (floppy (registered trademark) disk, hard disk drive (HDD), etc.) and an optical disk (Compact Disc ROM (CD-ROM), Digital Versatile Disc (DVD), Blu-ray Disc, etc.), a read only memory (ROM), a random access memory (RAM), an erasable programmable ROM (EPROM), an electrically erasable programmable ROM (EEPROM), a magnetic card, a flash memory, an optical card, and any type of medium that is suitable for storing electronic instructions.

What is claimed is:

1. An information processing apparatus that provides an online service associated with movement, the information processing apparatus comprising a control unit configured to:
acquire skill information that is information about driving skills of a predetermined user; and
give an incentive associated with the online service to the user based on the skill information.

2. The information processing apparatus according to claim 1, wherein the skill information is information indicating that the user previously received a first service related to acquisition of the driving skills using the online service.

3. The information processing apparatus according to claim 2, wherein the control unit is configured to acquire the skill information from a device associated with the first service.

4. The information processing apparatus according to claim 1, wherein the control unit is configured to acquire the skill information from a terminal carried when the user drives a vehicle.

5. The information processing apparatus according to claim 1, wherein the control unit is configured to sell a service to be provided at a predetermined spot through the online service.

6. The information processing apparatus according to claim 5, wherein the control unit is configured to generate a group including users who have purchased the service, and to select users who are targets to be given the incentive from among the group.

7. The information processing apparatus according to claim 6, wherein the control unit is configured to generate the group for each area of a destination.

8. The information processing apparatus according to claim 6, wherein the control unit is configured to generate the group for each area of a destination and for each time slot of arrival at the area.

9. The information processing apparatus according to claim 7, wherein the control unit is configured to divide the group further based on a degree of similarity of a path to the destination.

10. The information processing apparatus according to claim 6, wherein an upper limit number of users to be given the incentive is defined for each of the groups.

11. The information processing apparatus according to claim 6, wherein the control unit is configured to determine a driving skill level of the user based on the skill information.

12. The information processing apparatus according to claim 11, wherein the control unit is configured to give the incentive to the user acknowledged to have the driving skill level of a predetermined value or more.

13. An information processing system comprising:
a first device configured to provide an online service associated with movement; and
a second device configured to provide skill information that is information about driving skills of a user, wherein
the first device is configured to give an incentive associated with the online service to the user based on the skill information provided from the second device.

14. The information processing system according to claim 13, wherein the second device is a device associated with a first service related to acquisition of the driving skills, the second device being configured to provide the skill information when the user receives the first service using the online service.

15. The information processing system according to claim 13, wherein the first device is configured to sell a service to be provided at a predetermined spot through the online service.

16. The information processing system according to claim 15, wherein the first device is configured to generate a group including the users who have purchased the service, and to select the user who is a target to be given the incentive from among the group.

17. The information processing system according to claim 16, wherein the first device is configured to generate the group for each area of a destination.

18. The information processing system according to claim 16, wherein an upper limit number of the users to be given the incentive is defined for each of the groups.

19. The information processing system according to claim 13, wherein the first device is configured to determine a driving skill level of the user based on the skill information.

20. The information processing system according to claim 19, wherein the first device is configured to give the incentive to the user acknowledged to have the driving skill level of a predetermined value or more.
